(19) United States
(12) Patent Application Publication
(10) Pub. No.: US 2023/0196050 A1
(43) Pub. Date: Jun. 22, 2023

(54) Electronic apparatus and method of controlling the same

(71) Applicant: PAYCOQ CO., LTD., Seoul (KR)

(72) Inventor: Hae Won Kwon, Namyangju-si, Gyeonggi-do (KR)

(21) Appl. No.: 16/956,943

(22) PCT Filed: Jun. 8, 2020
(86) PCT No.: PCT/KR2020/007376

§ 371 Date: Jun. 22, 2020

(30) Foreign Application Priority Data
Feb. 12, 2020 (KR) 10-2020-0016956

(51) Int. Cl. G06K 19/07; G06K 7/00; G06V 30/10; G06V 10/54

(52) U.S. Cl. CPC G06K 19/0716; G06K 7/00; G06V 30/10; G06V 10/54

(57) ABSTRACT

Disclosed are an electronic apparatus and a method of controlling the same. With this, an integrated circuit (IC) chip provided in a card is recognized by identifying whether or not a signal is received from the card, optical character recognition is performed with regard to an image corresponding to the card, at least one of unevenness present on the card and material characteristics of the card is detected by performing image processing with regard to the image when the IC chip is not recognized, the card is identified as a real card in a case where the IC chip is recognized, and the card is identified as the real card when the unevenness is present on the card or the material characteristics are about the real card and the card is identified as a copy card when the unevenness is not present on the card and the material characteristics are not about the real card in a case where the IC chip is not recognized, under a condition that the card is provided to make payment based on the optical character recognition.

### CROSS-REFERENCE TO RELATED APPLICATION

This application is a Section 371 National Stage Application of International Application No. PCT/KR2020/007376, filed Jun. 8, 2020, which claims priority to Korean Patent Application Serial No. 10-2020-0016956, filed Feb. 12, 2020, the contents of which are hereby incorporated by reference in their entirety.

### TECHNICAL FIELD

The disclosure relates to an electronic apparatus and a method of controlling the same, and more particularly to an electronic apparatus which is able to prevent evolving card-payment fraud and security risk and a method of controlling the same.

### BACKGROUND ART

With development of financial technology (FinTech), a payment method or medium is improving variously. Recently, a credit card has been recognized by optical character recognition to input card information, or a mobile terminal of a buyer or seller has been used instead of a point-of-sale (POS) terminal, thereby making the card payment. In this case, there may be occurrence of evolving card-payment fraud or increase in security risk, which have previously been unexpected.

In a case of the optical character recognition, it is impossible to distinguish between a real credit card and a document or image obtained by copying or capturing the real credit card. For example, even when the optical character recognition is applied to a copy of the credit card, it is possible to obtain the same information as the information recognized by applying the optical character recognition to an original of the credit card. Therefore, when untact card payment without contact between a seller and a buyer is made based on the optical character recognition, a problem arises in that it is impossible to distinguish the copy of the credit card from the original of the credit card even though the copy of the credit card is presented instead of the original of the credit card.

The card information is security-sensitive information. However, data of the card information is automatically generated and stored in the mobile terminal of the buyer or seller while the card information is processed. Accordingly, there are a risk and an anxiety that a malicious third party may hack or intercept the data of the card information. Further, such a risk and an anxiety increase in the mobile terminal because the mobile terminal is more frequently maliciously accessed by the outside than the existing POS terminal.

### Technical Problem

An aspect of the disclosure is to provide an electronic apparatus, which is able to distinguish between an original of a credit card and a copy of the credit card when payment is made based on optical character recognition, and a method of controlling the same.

Further, an aspect of the disclosure is to provide an electronic apparatus, which is able to strengthen security of data automatically generated and stored while processing card information and thus decrease a risk of hacking or intercepting the data sensitive to the security, and a method of controlling the same.

The technical problems to be solved in the disclosure are not limited to the foregoing technical problems, and other unmentioned technical problems are also clearly understood by a person having ordinary knowledge in the art to which the embodiments proposed by the following description pertain.

### Technical Solution

According to an embodiment of the disclosure, an electronic apparatus includes: a recognizer configured to recognize an integrated circuit (IC) chip provided in a card by identifying whether or not a signal is received from the card; an image processor configured to perform optical character recognition with regard to an image corresponding to the card, and detect at least one of unevenness present on the card and material characteristics of the card by performing image processing with regard to the image when the IC chip is not recognized; and a controller configured to identify the card as a real card in a case where the IC chip is recognized, and identify the card as the real card when the unevenness is present on the card or the material characteristics are about the real card and identify the card as a copy card when the unevenness is not present on the card and the material characteristics are not about the real card in a case where the IC chip is not recognized, under a condition that the card is provided to make payment based on the optical character recognition.

In the electronic apparatus, the controller may be configured to: control the image processor to perform the optical character recognition with regard to the image and recognize card information needed for the payment when the card is identified as the real card; and control the image processor to stop the optical character recognition with regard to the image when the card is identified as the copy card.

In the electronic apparatus, the controller may be configured to: sequentially identify whether the unevenness is present on the card, and whether the material characteristics are about the real card; identify the card as the real card in a case where the unevenness is present on the card; and identify the card as the real card when the material characteristics are about the real card, but identify the card as the copy card when the material characteristics are not about the real card, in a case where the unevenness is not present on the card.

In the electronic apparatus, the material characteristics may include at least one of plastic characteristics, chip characteristics, magnetic characteristics, liquid crystal characteristics, picture characteristics, and paper characteristics; and the controller may identify that at least one of the plastic characteristics, the chip characteristics and the magnetic characteristics is about the real card.

In the electronic apparatus, the controller may be configured to obtain a plurality of reference images respectively corresponding to various materials, generate a histogram of brightness distribution in the plurality of reference images, and identify the material characteristics based on the histogram.

In the electronic apparatus, the controller is configured to: generate a plurality of pieces of dummy data, which has a same pattern as a pattern of the card information but is different from the card information, based on the card information; and store the plurality of pieces of dummy data in a memory area assigned to store intermediate data generated by software or a platform while the card information is processed.

In the electronic apparatus, the controller may be configured to randomly store the intermediate data and the plurality of pieces of dummy data not to match each other.

In the electronic apparatus, the intermediate data may include data intactly stored as unchanged while being stored in the memory area.

In the electronic apparatus, the controller may be configured to drive the software or the platform to process the card information, and delete the intermediate data stored in the memory area when the software or the platform is terminated.

According to another embodiment of the disclosure, a method of controlling an electronic apparatus includes: providing a card to make payment based on optical character recognition; recognizing an integrated circuit (IC) chip provided in the card by identifying whether or not a signal is received from the card; identifying the card as a real card when the IC chip is recognized; and detecting at least one of unevenness present on the card and material characteristics of the card by performing image processing with regard to the image when the IC chip is not recognized, identifying the card as the real card when the unevenness is present on the card or the material characteristics are about the real card, and identifying the card as a copy card when the unevenness is not present on the card or the material characteristics are not about the real card.

The method of controlling the electronic apparatus may further include: performing the optical character recognition with regard to the image and recognizing card information needed for the payment when the card is identified as the real card; and stopping the optical character recognition with regard to the image when the card is identified as the copy card.

The method of controlling the electronic apparatus may further include: sequentially identifying whether the unevenness is present on the card, and whether the material characteristics are about the real card; identifying the card as the real card in a case where the unevenness is present on the card; and identify the card as the real card when the material characteristics are about the real card, but identify the card as the copy card when the material characteristics are not about the real card, in a case where the unevenness is not present on the card.

In the method of controlling the electronic apparatus, the material characteristics include at least one of plastic characteristics, chip characteristics, magnetic characteristics, liquid crystal characteristics, picture characteristics, and paper characteristics, and the method may further include identifying that at least one of the plastic characteristics, the chip characteristics and the magnetic characteristics is about the real card.

The method of controlling the electronic apparatus may further include obtaining a plurality of reference images respectively corresponding to various materials, generating a histogram of brightness distribution in the plurality of reference images, and identifying the material characteristics based on the histogram.

The method of controlling the electronic apparatus may further include generating a plurality of pieces of dummy data, which has a same pattern as a pattern of the card information but is different from the card information, based on the card information; and storing the plurality of pieces of dummy data in a memory area assigned to store intermediate data generated by software or a platform while the card information is processed.

In the method of controlling the electronic apparatus, the intermediate data and the plurality of pieces of dummy data may be randomly stored not to match each other.

In the method of controlling the electronic apparatus, the intermediate data may include data intactly stored as unchanged while being stored in the memory area.

The method may further include driving the software or the platform to process the card information, and deleting the intermediate data stored in the memory area when the software or the platform is terminated.

According to still another embodiment of the disclosure, a computer-readable recording medium is recorded with a program for carrying out a method of controlling an electronic apparatus, the method including: providing a card to make payment based on optical character recognition; recognizing an integrated circuit (IC) chip provided in the card by identifying whether or not a signal is received from the card; identifying the card as a real card when the IC chip is recognized; and detecting at least one of unevenness present on the card and material characteristics of the card by performing image processing with regard to the image when the IC chip is not recognized, identifying the card as the real card when the unevenness is present on the card or the material characteristics are about the real card, and identifying the card as a copy card when the unevenness is not present on the card or the material characteristics are not about the real card.

### Advantageous Effects

According to embodiments of the disclosure, card-payment fraud is prevented by distinguishing between an original of a credit card and a copy of the credit card when payment is made based on optical character recognition.

Further, according to embodiments of the disclosure, security of data automatically generated and stored while card information is processed is strengthened, thereby decreasing a risk of hacking or intercepting the data sensitive to the security.

### DESCRIPTION OF DRAWINGS

FIG. 1 is a block diagram of an electronic apparatus according to the disclosure.

FIGS. 2A and 2B are views for describing a method that an electronic apparatus according to the disclosure recognizes an integrated circuit (IC) chip.

FIG. 3 is a view for describing a method that an electronic apparatus according to the disclosure recognizes unevenness present on a card.

FIG. 4 is a view for describing a method that an electronic apparatus according to the disclosure identifies material characteristics of a card.

FIG. 5 is a view of a control process in an electronic apparatus according to an embodiment of the disclosure.

FIGS. 6A and 6B are views for describing that general software processes data.

FIGS. 7A and 7B are views for describing plurality of pieces of dummy data generated by an electronic apparatus according to the disclosure.

FIG. 8 is a view of a control process in an electronic apparatus according to another embodiment of the disclosure.

### BEST MODE

Below, embodiments of the disclosure will be described in detail with reference to the accompanying drawings. However, technical concept of the disclosure is not limited to the embodiments set forth herein, and retrogressive embodiments or other embodiments may be easily proposed within the scope of the technical concept of the disclosure by adding, changing, removing, etc. another element.

Terms used in the disclosure are selected among the terms generally and widely used in the art if possible. However, there may be terms discretionarily chosen by the applicant in special cases, and in this case the meaning thereof will be explained in the detailed description. Therefore, the disclosure should be grasped based on not the term itself but the meaning of the term. In the following description, term ‘include’ does not exclude presence of elements or operations other than those listed above.

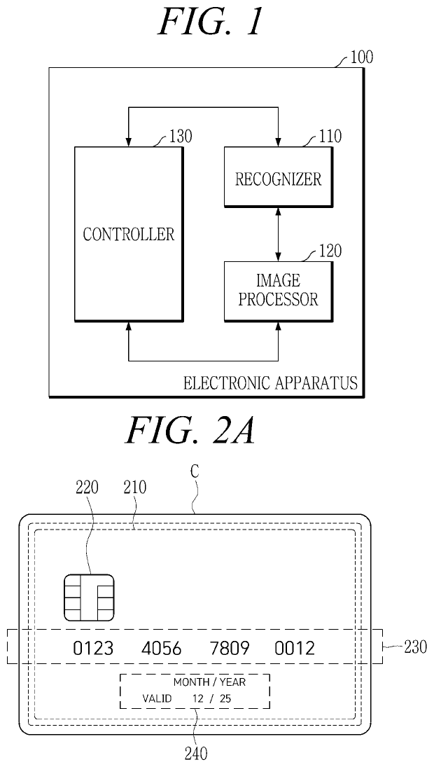

FIG. 1 is a block diagram of an electronic apparatus according to the disclosure.

The electronic apparatus 100 according to the disclosure refers to an apparatus that makes payment based on various payment methods such as optical character recognition (OCR), near field communication (NFC), etc., and may be embodied by various electronic apparatuses such as a mobile terminal, a tablet terminal, a personal computer, a laptop computer, etc.

In this case, the electronic apparatus 100 may be embodied by an apparatus or server provided in at least one main agent among all the main agents related to payment procedures, such as an apparatus of the buyer, an apparatus of the seller, a payment mediation server, a value added network (VAN) company server, a card company server, etc.

The electronic apparatus 100 according to the disclosure may include a recognizer 110, an image processor 120, and a controller 130.

The recognizer 110 may be configured to identify whether a signal is received from a card, and recognize an integrated circuit (IC) chip included in the card.

Here, the signal may include a radio frequency (RF) signal, a magnetic signal, etc. However, the disclosure is not limited to these signals, and the signal refers to a signal capable of carrying card information based on any communication method, which may include any signal based on not only the current communication method but also a communication method absent at this time but presentable in the future.

The IC chip is configured to store the card information. When a radio wave is received in the IC chip, an electric current is instantaneously induced. In this case, the IC chip generates a signal based on the induced current, and transmits the card information through the signal.

Referring to this, when the card is close to the electronic apparatus 100, the IC chip may receive a radio wave from the electronic apparatus 100 and generate a signal. Therefore, the electronic apparatus 100 may recognize that the card has the IC chip, based on the signal received from the card. In this case, the card is identified as a tangible real card because the IC chip is present in the card.

According to an embodiment, the recognizer 110 may recognize the IC chip included in the card based on at least one of whether the signal is received or not and the strength of the received signal.

The image processor 120 may apply optical character recognition to an image corresponding to the card.

When the IC chip is not recognized, the image processor 120 may perform image processing with regard to the image corresponding to the card, and detect at least one of unevenness on the card and material characteristics of the card.

When the card is presented to make payment based on optical character recognition, the controller 130 may identify whether the card is a real card or a copy card. According to the disclosure, the real card is defined as a tangible original card. Further, the copy card is defined as a document or image obtained by copying or capturing the original card. In this case, the copy card is different from a counterfeit card that is made to look exactly like the real card.

According to an embodiment, the controller 130 may sequentially identify whether the IC chip is recognized, whether the unevenness is present or not, or the material characteristics of the card. Specifically, when the IC chip is recognized, the controller 130 may identify the card as the real card. On the other hand, when the IC chip is not recognized, the controller 130 may identify whether the unevenness is present or not, or the material characteristics of the card. In this case, the controller 130 may identify the card as the real card when the unevenness is present or the material characteristics are about the real card, but identify the card as the copy card when the unevenness is not present and the material characteristics are not about the real card.

The real card displays the card information. The card information may be embossed to be raised above or engraved to be recessed into the card. In this case, the unevenness is present on the surface of the card. Alternatively, the card information may be displayed as printed on the card. In this case, the unevenness is not present on the surface of the card.

Therefore, when the unevenness is present on the surface of the card, it means that the card information is embossed or engraved, and therefore the card is identified as the real card. On the other hand, when the unevenness is not present on the surface of the card, the card information may be given as printed, and it is not obvious that the card is the copy card. In this case, it is further identified that the material characteristics of the card are related to the real card, thereby identifying whether the card is the real card or the copy card.

The controller 130 obtains a plurality of reference images respectively corresponding to various materials, generates a histogram of brightness distribution included in the plurality of reference images, and identifies the material characteristics based on the histogram.

The material characteristics may include plastic characteristics, chip characteristics, magnetic characteristics, liquid crystal characteristics and paper characteristics. The controller 130 may identify the plastic characteristics, the chip characteristics and the magnetic characteristics are about the real card.

According to an exemplary embodiment, the controller 130 may sequentially identify whether the IC chip is recognized, whether the unevenness is present, and whether the material characteristics are about the real card. Specifically, when the IC chip is recognized, the controller 130 may identify the card as the real card. On the other hand, when the IC chip is not recognized, the controller 130 performs a process of identifying the presence of the unevenness. In this case, when the unevenness is present on the card, the controller 130 identifies the card as the real card. On the other hand, when the unevenness is not present on the card, the controller 130 performs a process of identifying the material characteristics of the card. Based on the results of identifying the material characteristics, the controller 130 may identify the card as the real card when the material characteristics are about the real card, but identify the card as the copy card when the material characteristics are not about the real card.

In terms of distinguishing between the real card and the copy card, the simplest and easiest method is to recognize the IC chip. In this case, it is enough to identify whether the signal is received or not. On the other hand, the most complicated and longest method is to identify the material characteristics. In this case, the material characteristics of the real card and the copy card are analyzed, and it is identified which one of the analyzed material characteristics is similar to the material characteristics of the card.

Therefore, the controller 130 sequentially identifies whether the IC chip is recognized, whether the unevenness is present, and whether the material characteristics of the card are about the real card, thereby carrying out a process optimized to distinguish between the real card and the copy card.

The controller 130 may differently apply the optical character recognition according to whether the card is the real card or the copy card. Specifically, when the card is identified as the real card, the controller 130 may control the image processor 120 to apply the optical character recognition to the image and to recognize the card information needed for payment. On the other hand, when the card is identified as the copy card, the controller 130 may control the image processor 120 to stop applying the optical character recognition to the image.

The controller 130 may generate a plurality of pieces of dummy data having the same pattern as the pattern of the card information but different from the card information, based on the card information. In this case, the controller 130 may store the plurality of pieces of dummy data in a memory area assigned to store intermediate data. Here, the intermediate data refers to data generated by software or a platform and automatically stored while the card information is processed.

According to an embodiment, the intermediate data may be data intactly stored without changed while being stored in the memory area. In this case, the controller 130 may delete the intermediate data from the memory area when a program is terminated. For example, when a Java program is driven to process the card information, the intermediate data may be generated by an object for storing a series of program characters. Here, the series of characters is a subject to store a plurality of characters. The series of characters in the Java program is a string type.

The controller 130 may control the intermediate data and the plurality of pieces of dummy data to be randomly stored without matching each other.

According to embodiments, when the dummy data will be generated may be varied. The controller 130 may generate the plurality of pieces of dummy data before the intermediate data is generated, or generate the plurality of pieces of dummy data after the intermediate data is generated.

The controller 130 may drive the software or the platform to process the card information, and delete the intermediate data stored in the memory area when the software or the platform is terminated.

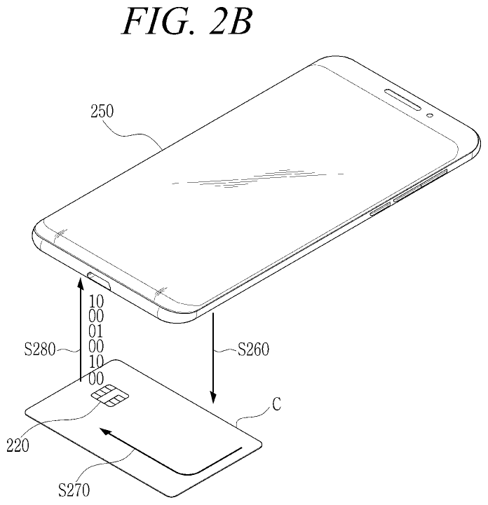

FIGS. 2A and 2B are views for describing a method that an electronic apparatus according to the disclosure recognizes an IC chip.

Specifically, FIG. 2A shows a credit card. For convenience of description, FIG. 2A illustrates a case that a card is the credit card, by way of example. However, the disclosure is not limited to this. According to the disclosure, the card may include not only the credit card but also a check card and any card as long as it can be used for payment.

On the front and back sides of the credit card, a card number, an expiration date, an owner's name, a signature, and the like card information may be displayed. The card information may be embossed or engraved, or may be printed.

The IC chip, in which the card information is stored, is mounted to the front side of the credit card. Inside the credit card, a magnetic coil is provided to generate an induced current in the IC chip.

Referring to FIG. 2A, a magnetic coil 210 is provided inside the credit card C along card edges. In a left upper portion on the front side of the credit card C, an IC chip 220 is attached. In a lower portion on the front side of the card C, a card number 230 and an expiration date 240 are displayed.

FIG. 2B illustrates a case where the IC chip transmits a signal. The magnetic coil inside the credit card generates an induced current when receiving a radio wave, and thus the induced current is generated in the IC chip. The IC chip can generate a signal based on the induced current, and transmit the card information through the signal.

As shown in FIG. 2B, the card C is positioned within a predetermined distance from and close to a mobile terminal 250. In this case, the magnetic coil inside the card C receives a radio wave from the mobile terminal 250 (S260), and generates an induced current (S270). The generated induced current is transmitted to the IC chip 220, and the IC chip 220 transmits the card information to the mobile terminal 250 by generating a signal based on the induced current (S280).

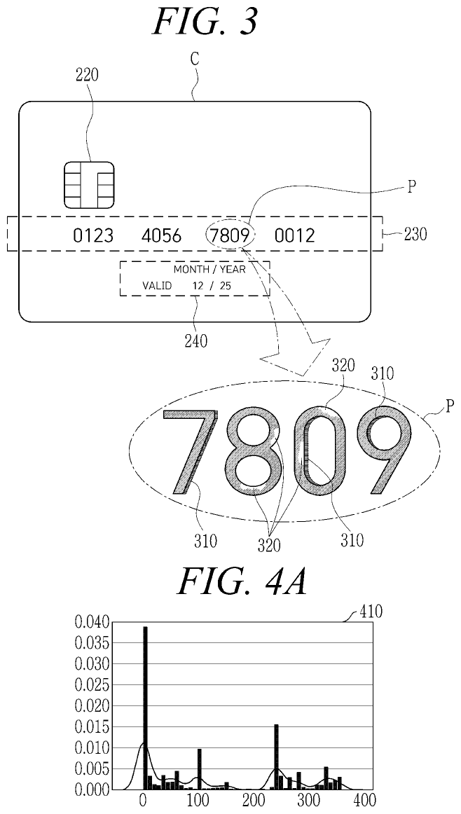

FIG. 3 is a view for describing a method that an electronic apparatus according to the disclosure recognizes unevenness present on a card.

As described above, when the card information is embossed or engraved on the card C, the unevenness is present on the card.

Because some portions of the unevenness are worn out by continuous use, the unevenness may have a worn-out portion. In the worn-out portion, a color printed on the surface of the card comes off and therefore an inner skin of the card is exposed. Because the inner skin and the color printed of the card are different in material from each other, they are also different in absorbance and reflectivity of light.

Further, the unevenness minutely causes a shade area in the card C. Light reaching the shade area and light reaching the other area are different in amount. Thus, brightness distribution is differently analyzed between the shade area and the other area.

Therefore, an image histogram of the card C is drawn and analyzed to recognize the unevenness on the card based on irregularity of light shown in the image histogram. Although the card C looks the same as the document or image of the card C with naked eyes, the analyzed image histogram shows that they are different in brightness distribution from each other according to materials, absorbance or reflectivity of light.

Specifically, when a card number area includes an area where the brightness distribution is varied, it may be identified that a certain portion of the card number is worn out showing different materials and thus reflectivity of light is varied in this portion. In the case of the document or image obtained by copying or capturing the card, the material is uniform, and thus the reflectivity of light is constant throughout the whole area, thereby showing a constant brightness distribution in the image histogram.

Further, when the brightness distribution is varied in only a certain area among the areas surrounding the card number, it may be identified that the amount of light reaching the corresponding area is varied because of the shade in the corresponding area. On the other hand, in the case of the document or image obtained by copying or capturing the card, there is no shade because unevenness is absent, and thus the amount of light reaching the whole areas is uniform, thereby showing the constant brightness distribution in the image histogram.

Preferably, when the image histogram is drawn, the image of the card C is converted by a gray model to drawn the image histogram of the converted image. The gray model represents an image based on only brightness information without using color information, and image pixel values are represented with intensity of a total of 256 levels from black of ‘0’ to white of ‘255’.

Referring to FIG. 3, the unevenness is formed on the card C as the card number 230 is embossed on the card C. When a certain portion P of the card number 230 is zoomed in, a minute shade area 310 is present around the unevenness, and the unevenness includes a worn-out portion 320. In this case, it is possible to identify the presence of the unevenness by drawing the image histogram of the card C and analyzing the brightness distribution.

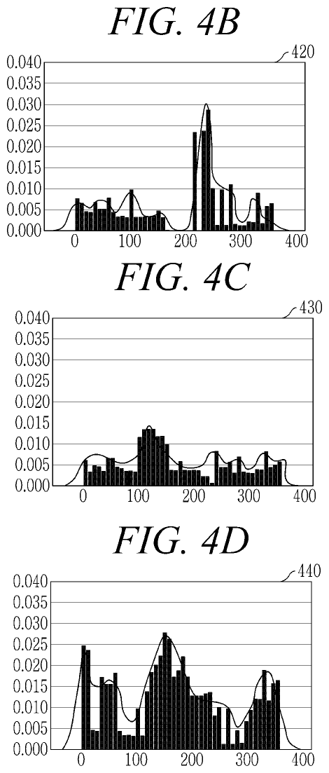

FIG. 4 is a view for describing a method that an electronic apparatus according to the disclosure identifies material characteristics of a card.

The electronic apparatus 100 may identify the material characteristics of the card based on the image histogram corresponding to the card. Specifically, a plurality of reference images respectively corresponding to various materials is obtained, and histograms of brightness distribution included in the plurality of reference images are drawn, so as to identify material characteristics based on the histogram.

The material characteristics may include plastic characteristics, chip characteristics, magnetic characteristics, picture characteristics, liquid crystal characteristics, paper characteristics, etc. The materials are different in reflectivity and absorbance of the light. In this case, the materials are different in the brightness distribution, and thus the brightness distribution of each individual material in the image histogram may have a predetermined pattern.

Referring to FIG. 4, the brightness distribution histograms according to the materials are shown. In this case, (a) shows a brightness distribution pattern of plastic, (b) shows a brightness distribution pattern of a chip, (c) shows a brightness distribution pattern of picture, and (d) shows a brightness distribution pattern of paper. Referring to this, each individual brightness distribution pattern shows a certain pattern. Therefore, a brightness distribution pattern of a given card is analyzed with reference to the brightness distribution patterns according to the materials, and the material characteristics of the card are identified.

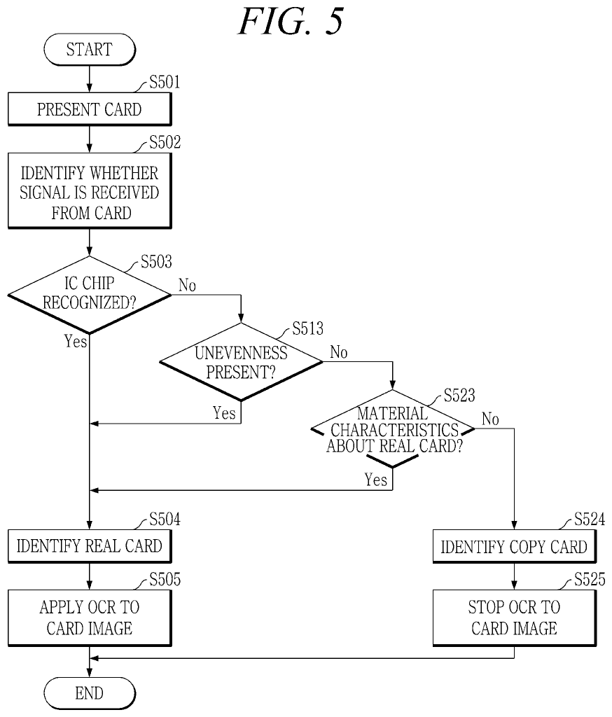

FIG. 5 is a view of a control process in an electronic apparatus according to an embodiment of the disclosure.

A card is provided (S501).

To make payment based on the optical character recognition, the card is presented within a predetermined distance from the electronic apparatus 100.

It is identified whether a signal is received from the card (S502).

The IC chip generates an induced current when receiving a radio wave from the electronic apparatus 100, and thus transmits a signal. Therefore, the electronic apparatus 100 identifies whether the signal is received from the card, and recognizes the IC chip included in the card.

When the IC chip is recognized (YES in S503), the card is identified as the real card (S504).

A tangible real card generally includes the IC chip. Therefore, the card is identified as the real card when the IC chip is recognized.

On the other hand, when the IC chip is not recognized (NO in S503), it is identified whether unevenness is present on the card (S513).

Although the card is the real card, the IC chip may not be recognized. For example, the strength of the signal received from the card may be very weak, the signal of the IC chip may not be receivable as the card is positioned beyond a predetermined signal-receivable distance from the electronic apparatus 100, or the stored card information may be transmitted by not the signal transmission but another way.

Therefore, to correct an error that the card in the foregoing cases is mistaken as the copy card, the electronic apparatus 100 further identifies whether the unevenness is present on the card. In this case, the electronic apparatus 100 performs image processing with regard to an image corresponding to the card, thereby detecting the unevenness present on the card. Specifically, the electronic apparatus 100 draws and analyzes the image histogram for the card, and recognizes the unevenness present on the card based on irregularity of light shown in the image histogram.

When the unevenness is present on the card (YES in S513), the card is identified as the real card (S504).

When the unevenness is present on the card, it means that the card information is embossed or engraved, and it is thus identified that the card is the real card.

On the other hand, when the unevenness is absent on the card (NO in S513), it is further identified whether the card has the material characteristics of the real card (S523).

The card information may be printed on the surface of the card instead of the unevenness. Therefore, even though the unevenness is absent on the card, it is not obvious that the card is the copy card. In this case, it is further identified whether the material characteristics of the card are about the real card, thereby identifying whether the card is the real card or the copy card.

To this end, the electronic apparatus 100 perform image processing with regard to the image corresponding to the card, and identify the material characteristics of the card. Specifically, the electronic apparatus 100 may identify the material characteristics of the card based on the image histogram of the card. Specifically, the plurality of reference images is obtained corresponding to various materials, and the histograms about the brightness distribution in the plurality of reference images are drawn, thereby identifying the material characteristics based on the histogram.

When the card has the material characteristics of the real card (YES in S523), the card is identified as the real card (S504).

The material characteristics may include at least one among the plastic characteristics, the chip characteristics, the magnetic characteristics, the liquid crystal characteristics, picture characteristics and the paper characteristics. The electronic apparatus 100 may identify that the plastic characteristics, the chip characteristics and the magnetic characteristics are about the real card. However, the disclosure is not limited to this example, and the material characteristics of the real card may be variously modified and set according to embodiments.

When the card does not have the material characteristics of the real card (NO in S523), the card is identified as the copy card (S524).

Meanwhile, when the card is identified as the real card in the operation S504, the optical character recognition is applied to the card image, and the card information needed for the payment is recognized (S505). On the other hand, when the card is identified as the copy card in the operation S524, the optical character recognition for the card image is stopped (S525).

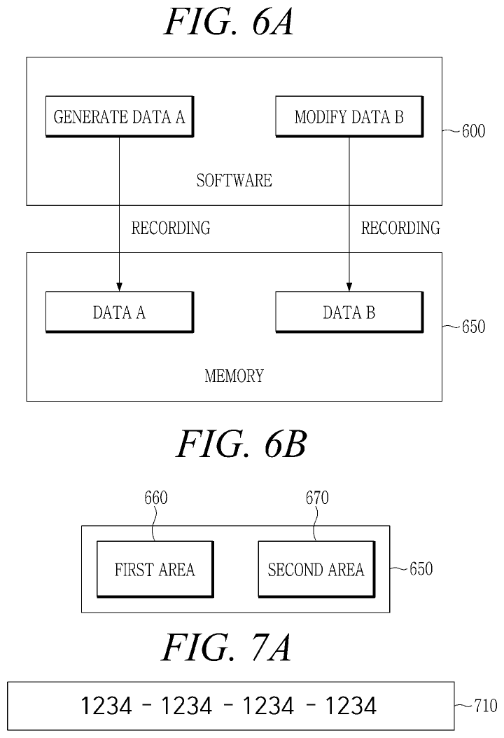

FIGS. 6A and 6B are views for describing that general software processes data.

Specifically, FIG. 6A shows a case where software records data in a memory. When the electronic apparatus 100 executes the software (or program) to process the card information, the software may perform various kinds of jobs to process the data. When data is created or modified while the software is running, the corresponding data is essentially recorded in the memory. Therefore, the data created or modified during the operation of the software is all recorded in the memory.

Referring to FIG. 6A, software 600 generates data A, and records the generated data A in a memory 650. Further, the software 600 modifies data B and records the modified data B in the memory 650.

FIG. 6B illustrates the structure of the memory 650. The memory 650 is configured to store the data. In this case, the memory 650 may include a first area 660 and a second area 670.

The first area 660 refers to a memory area configured to store basic-type data. The basic-type data may be defined as final data used at a user level. The basic-type data may be accessible at the user level. Therefore, a user may store, modify or delete the basic-type data. When the basic-type data is deleted, the basic-type data stored in the first area 660 is deleted. Further, a user may set the basic-type data not to be stored. When the basic-type data is set not to be stored, the electronic apparatus 100 may not store the basic-type data in the first area 660.

The second area 670 refers to a memory area configured to store the reference-type data. The reference-type data may be defined as an intermediate-type data used at a software or platform level. The software may automatically generate the reference-type data in a process for drawing the final data, and store the reference-type data in the second area 670. The reference-type data is hardly accessed at a general user level, but is accessible by a programmer or a manager having professional knowledge. In the process of processing the card information according to the disclosure, the intermediate data generated by the software or the platform is equivalent to such reference-type data.

The reference-type data stored in the second area 670 may be data unchangeable while being stored in the memory. In this case, when the reference-type data is generated and stored in the second area 670, the stored reference-type data is not changed or deleted until the software or the program is terminated. In other words, once the reference-type data is stored in the memory, it is possible to change or delete the reference-type data only after the software or the program is terminated.

The intermediate data automatically generated while the electronic apparatus 100 processes the card information and recorded in the memory includes data sensitive to security. However, the intermediate data is retained and stored in the memory until the program is terminated, thereby causing an information-security problem of hacking or interception.

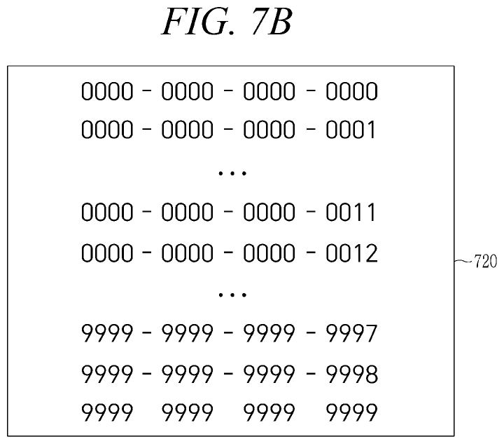

FIGS. 7A and 7B are views for describing plurality of pieces of dummy data generated by an electronic apparatus according to the disclosure.

The electronic apparatus 100 may generate the plurality of pieces of dummy data, which has the same pattern as the pattern of the card information but is different from the card information, based on the card information. In this case, the electronic apparatus 100 may store the plurality of pieces of dummy data in the memory area assigned to store the intermediate data. Here, the intermediate data may be data generated by the software or the program while the card information is being processed.

Specifically, FIG. 7A illustrates an example of a card number 710. The electronic apparatus 100 may analyze the card number 710, thereby analyzing a type, a pattern, etc. of the card number. For example, there may be a digit number, a number pattern, etc. of the card number. Referring to FIG. 7A, the card number 710 is provided as a 16-digit number, and divided into four groups of four numerals.

FIG. 7B illustrates a plurality of pieces of dummy data 720 stored in the memory area. The electronic apparatus 100 generates the plurality of pieces of dummy data 720 based on the card number 710. The plurality of pieces of dummy data 720 are provided as a 16-digit number and divided into four groups of four numerals like the pattern of the card number 710. Further, the plurality of pieces of dummy data 720 is configured differently from the card number 710.

The plurality of pieces of dummy data 720 is stored in the memory area assigned to store the intermediate data. Therefore, it is impossible to distinguish between the dummy data 720 and the intermediate data automatically generated and stored while the card number 710 is processed, even though the memory area is scanned. Therefore, it is possible to strengthen the security of the security-sensitive card information.

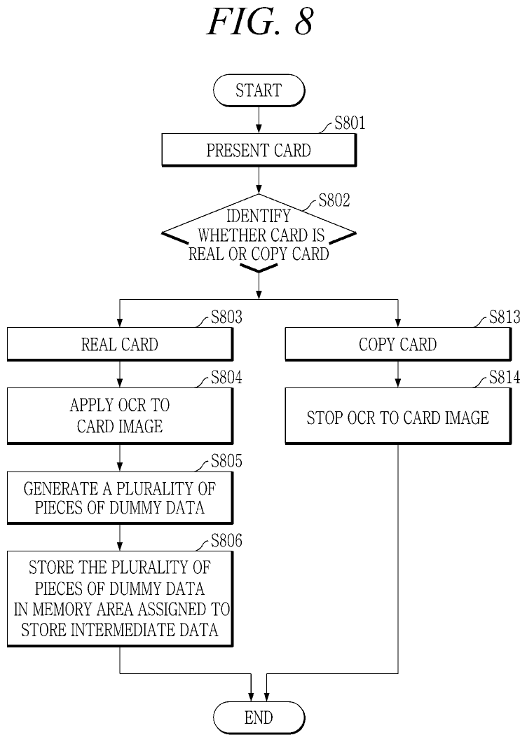

FIG. 8 is a view of a control process in an electronic apparatus according to another embodiment of the disclosure.

A card is provided (S801).

To make payment based on the optical character recognition, the card is presented within a predetermined distance from the electronic apparatus 100.

It is identified whether the card is a real card or a copy card (S802).

The electronic apparatus 100 identifies whether the given card is the real card or the copy card. The detailed method and operations of the identification are the same as described above, and thus repetitive descriptions thereof will be avoided.

When the card is identified as the real card (S803), the optical character recognition is applied to the card image (S804). In this case, the card information is extracted from the card image by the optical character recognition, and the electronic apparatus 100 drives the program to process the card information. In the operation of processing the card information, the intermediate data is automatically generated and stored.

A plurality of pieces of dummy data is generated (S805). The electronic apparatus 100 may analyze a pattern of the card information, and generate the plurality of pieces of dummy data based on the analyzed pattern. In this case, the plurality of pieces of dummy data may be provided as data that has the same pattern as the pattern of the card information but is different from the card information.

The plurality of pieces of dummy data is stored in the memory area assigned to store the intermediate data (S806). In this case, the electronic apparatus 100 may randomly store the intermediate data and the plurality of pieces of dummy not to match each other.

The intermediate data generated while the card information is processed is automatically stored in the assigned memory area. Therefore, the electronic apparatus 100 stores the plurality of pieces of dummy data in the memory area assigned to store the intermediate data. Thus, the plurality of pieces of dummy data having the same pattern as the intermediate data is stored together with the intermediate data in the same memory area.

Meanwhile, when the card is identified as the copy card (S813), the electronic apparatus 100 stops the optical character recognition with regard to the card image (S814).

Data generated during operation of software may be automatically stored in the memory. When the generated data is sensitive to security, a manager may directly access the memory to delete the data, or perform management by putting the data on a tracking management list whenever the data is generated. However, in this case, not only it is inconvenient to manage data generated in real time, but also it is not easy for a general user who has no professional knowledge to carry out such management.

According to this embodiment, when the card information sensitive to the security is processed, the dummy data of the same pattern is also generated and stored together in the memory, and it is therefore impossible to distinguish between the intermediate data generated during the process of the card information and the dummy data even though the memory is scanned. Accordingly, the security of the sensitive intermediate data is improved, and the security or reliability of the card payment is guaranteed.

Meanwhile, the foregoing method may be written as a program executable in a computer, and embodied in a universal digital computer for operating the program using a computer readable medium. Further, the structure of the data used in the foregoing method may be recorded in the computer readable medium through various means. The recording medium for recording a computer program or a code executable to carry out various methods of the disclosure should be construed excluding transitory things like carrier waves or signals. The computer readable medium may include a magnetic storage medium (e.g. a read only memory (ROM), a floppy disk, a hard disk drive, etc.), an optical readable medium (e.g. a compact disc (CD)-ROM, a digital versatile disc (DVD), etc.) and the like storage medium.

Although a few embodiments have been described, it will be appreciated by a person having an ordinary skill in the art that the embodiments are merely examples, do not limit the disclosure, and various changes and applications not illustrated above can be made without departing from the fundamental features of the embodiments. For example, the elements specifically shown in the embodiments may be changed and embodied. Further, differences from such changes and applications are construed as being included in the scope of the disclosure stipulated in the appended claims.

1. An electronic apparatus comprising:
a recognizer configured to recognize an integrated circuit (IC) chip provided in a card by identifying whether or not a signal is received from the card;
an image processor configured to perform optical character recognition with regard to an image corresponding to the card, and detect at least one of unevenness present on the card and material characteristics of the card by performing image processing with regard to the image when the IC chip is not recognized; and
a controller configured to identify the card as a real card in a case where the IC chip is recognized, and identify the card as the real card when the unevenness is present on the card or the material characteristics are about the real card and identify the card as a copy card when the unevenness is not present on the card and the material characteristics are not about the real card in a case where the IC chip is not recognized, under a condition that the card is presented to make payment based on the optical character recognition.

2. The electronic apparatus according to claim 1, wherein the controller is configured to:
control the image processor to perform the optical character recognition with regard to the image and recognize card information needed for the payment when the card is identified as the real card; and
control the image processor to stop the optical character recognition with regard to the image when the card is identified as the copy card.

3. The electronic apparatus according to claim 1, wherein the controller is configured to:
sequentially identify whether the unevenness is present on the card, and whether the material characteristics are about the real card;
identify the card as the real card in a case where the unevenness is present on the card; and
identify the card as the real card when the material characteristics are about the real card, but identify the card as the copy card when the material characteristics are not about the real card, in a case where the unevenness is not present on the card.

4. The electronic apparatus according to claim 1, wherein:
the material characteristics comprise at least one of plastic characteristics, chip characteristics, magnetic characteristics, liquid crystal characteristics, picture characteristics, and paper characteristics; and
the controller identifies that at least one of the plastic characteristics, the chip characteristics and the magnetic characteristics is about the real card.

5. The electronic apparatus according to claim 1, wherein the controller is configured to obtain a plurality of reference images respectively corresponding to various materials, generate a histogram of brightness distribution in the plurality of reference images, and identify the material characteristics based on the histogram.

6. The electronic apparatus according to claim 2, wherein the controller is configured to:
generate a plurality of pieces of dummy data, which has a same pattern as a pattern of the card information but is different from the card information, based on the card information; and
store the plurality of pieces of dummy data in a memory area assigned to store intermediate data generated by software or a platform while the card information is processed.

7. The electronic apparatus according to claim 6, wherein the controller is configured to randomly store the intermediate data and the plurality of pieces of dummy data not to match each other.

8. The electronic apparatus according to claim 6, wherein the intermediate data comprises data intactly stored as unchanged while being stored in the memory area.

9. The electronic apparatus according to claim 6, wherein the controller is configured to drive the software or the platform to process the card information, and delete the intermediate data stored in the memory area when the software or the platform is terminated.

10. A method of controlling an electronic apparatus, comprising:
presenting a card to make payment based on optical character recognition;
recognizing an integrated circuit (IC) chip provided in the card by identifying whether or not a signal is received from the card;
identifying the card as a real card when the IC chip is recognized; and
detecting at least one of unevenness present on the card and material characteristics of the card by performing image processing with regard to the image when the IC chip is not recognized, identifying the card as the real card when the unevenness is present on the card or the material characteristics are about the real card, and identifying the card as a copy card when the unevenness is not present on the card and the material characteristics are not about the real card.

11. The method according to claim 10, further comprising:
performing the optical character recognition with regard to the image and recognizing card information needed for the payment when the card is identified as the real card; and
stopping the optical character recognition with regard to the image when the card is identified as the copy card.

12. The method according to claim 10, further comprising:
sequentially identifying whether the unevenness is present on the card, and whether the material characteristics are about the real card;
identifying the card as the real card in a case where the unevenness is present on the card; and
identify the card as the real card when the material characteristics are about the real card, but identify the card as the copy card when the material characteristics are not about the real card, in a case where the unevenness is not present on the card.

13. The method according to claim 10, wherein:
the material characteristics comprise at least one of plastic characteristics, chip characteristics, magnetic characteristics, liquid crystal characteristics, picture characteristics, and paper characteristics,
the method further comprises identifying that at least one of the plastic characteristics, the chip characteristics and the magnetic characteristics is about the real card.

14. The method according to claim 10, further comprising:
obtaining a plurality of reference images respectively corresponding to various materials, generating a histogram of brightness distribution in the plurality of reference images, and identifying the material characteristics based on the histogram.

15. The method according to claim 11, further comprising:
generating a plurality of pieces of dummy data, which has a same pattern as a pattern of the card information but is different from the card information, based on the card information; and
storing the plurality of pieces of dummy data in a memory area assigned to store intermediate data generated by software or a platform while the card information is processed.

16. The method according to claim 15, wherein the intermediate data and the plurality of pieces of dummy data are randomly stored not to match each other.

17. The method according to claim 15, wherein the intermediate data comprises data intactly stored as unchanged while being stored in the memory area.

18. The method according to claim 15, further comprising driving the software or the platform to process the card information, and deleting the intermediate data stored in the memory area when the software or the platform is terminated.

19. A computer-readable recording medium recorded with a program for carrying out a method of controlling an electronic apparatus, the method comprising:
presenting a card to make payment based on optical character recognition;
recognizing an integrated circuit (IC) chip provided in the card by identifying whether or not a signal is received from the card;
identifying the card as a real card when the IC chip is recognized; and
detecting at least one of unevenness present on the card and material characteristics of the card by performing image processing with regard to the image when the IC chip is not recognized, identifying the card as the real card when the unevenness is present on the card or the material characteristics are about the real card, and identifying the card as a copy card when the unevenness is not present on the card and the material characteristics are not about the real card.
